(19) United States
(12) Patent Application Publication
(10) Pub. No.: US 2025/0203025 A1
(43) Pub. Date: Jun. 19, 2025

(54) IMAGE READING DEVICE, IMAGE READING METHOD, AND PROGRAM

(71) Applicant: SEIKO EPSON CORPORATION, Tokyo (JP)

(72) Inventor: Masahiro IGARASHI, KITAKYUSHU-SHU (JP)

(21) Appl. No.: 19/069,621

(22) Filed: Mar. 4, 2025

Related U.S. Application Data
(63) Continuation of application No. 18/162,586, filed on Jan. 31, 2023.

(30) Foreign Application Priority Data
Feb. 1, 2022 (JP) 2022-014248

(51) Int. Cl. H04N 1/00

(52) U.S. Cl. CPC H04N 1/00588; H04N 1/00535; H04N 1/00602; H04N 1/00612; H04N 1/00631; H04N 1/00811

(57) ABSTRACT

An image reading device includes a conveyance unit configured to convey a carrier sheet and a reading object, a reading unit configured to read an image of the reading object, a display unit configured to receive an input of information about whether the reading object is conveyed using the carrier sheet, and a control unit configured to determine whether the reading object is being conveyed using the carrier sheet. The control unit performs predetermined processing on the image read by the reading unit when it is determined that the reading object is being conveyed using the carrier sheet. The control unit does not perform the predetermined processing on the image read by the reading unit when it is determined that the reading object is being conveyed without using the carrier sheet.

The present application is a continuation of U.S. patent application Ser. No. 18/162,586, filed on Jan. 31, 2023, which is based on, and claims priority from JP Application Serial Number 2022-014248, filed Feb. 1, 2022, the disclosures of which are hereby incorporated by reference herein in their entirety.

### BACKGROUND

### 1. Technical Field

The present disclosure relates to an image reading device, an image reading method, and a program.

### 2. Related Art

JP-A-2019-193159 discloses an image reading device that can read an image while conveying a normal document and a special document such as a booklet. In such an image reading device, a normal reading mode for reading a normal document and a booklet reading mode for reading a special document can be set in advance. When the booklet reading mode is selected, the image reading device performs image processing on the image data read in the booklet reading mode based on the difference of the background image data.

However, in the above-described image reading device, with the booklet reading mode selected, the user may perform an operation of causing a document different from those assumed for the booklet reading mode to be read, for example. In such a case, the image processing may not be appropriately performed for the image data of the document read in the booklet reading mode. Accordingly, the image may not be appropriately read.

### SUMMARY

An image reading device for solving the above-described problems includes a conveyance unit configured to convey a carrier sheet and a reading object, the carried sheet being configured to sandwich the reading object thicker than a document, a reading unit configured to read an image of the reading object conveyed by the conveyance unit, a reception unit configured to receive an input of information about whether the reading object is conveyed using the carrier sheet, and a control unit configured to determine whether the reading object is being conveyed using the carrier sheet and control the reception unit, wherein in a case in which information indicating that the reading object is conveyed using the carrier sheet is received by the reception unit, the control unit performs predetermined processing on the image read by the reading unit when it is determined that the reading object is being conveyed using the carrier sheet and the control unit does not perform the predetermined processing on the image read by the reading unit when it is determined that the reading object is being conveyed without using the carrier sheet.

An image reading method for solving the above-described problems is an image reading method in an image reading device, the image reading device including a conveyance unit configured to convey a carrier sheet and a reading object, the carried sheet being configured to sandwich the reading object thicker than a document, a reading unit configured to read an image of the reading object conveyed by the conveyance unit, and a reception unit configured to receive an input of information about whether the reading object is conveyed using the carrier sheet, the image reading method including, determining whether the reading object is being conveyed using the carrier sheet, when information indicating that the reading object is conveyed using the carrier sheet is received by the reception unit, performing predetermined processing on the image read by the reading unit when the reading object is being conveyed using the carrier sheet and not performing the predetermined processing on the image read by the reading unit when the reading object is being conveyed without using the carrier sheet.

A program for solving the above-described problems is a non-transitory computer-readable storage medium storing a program executed by a computer included in an image reading device, the image reading device including a conveyance unit configured to convey a carrier sheet and a reading object, the carried sheet being configured to sandwich the reading object thicker than a document, a reading unit configured to read an image of the reading object conveyed by the conveyance unit, and a reception unit configured to receive an input of information about whether the reading object is conveyed using the carrier sheet, the program being configured to cause the computer to, determining whether the reading object is being conveyed using the carrier sheet, when information indicating that the reading object is conveyed using the carrier sheet is received by the reception unit, perform predetermined processing on the image read by the reading unit when the reading object is being conveyed using the carrier sheet and not perform the predetermined processing on the image read by the reading unit when the reading object is being conveyed without using the carrier sheet.

### BRIEF DESCRIPTION OF THE DRAWINGS

FIG. 1 is a schematic side view of an image reading device when a device body is in a first posture in an embodiment.

FIG. 2 is a schematic side view of the image reading device when the device body is in a second posture.

FIG. 3 is a block diagram illustrating an electrical configuration of the image reading device.

FIG. 4 is a schematic plan view illustrating a state where a passport is sandwiched in a carrier sheet.

FIG. 5 is a schematic view illustrating an example of image data of the passport using the carrier sheet.

FIG. 6 is a flowchart illustrating an image reading processing routine.

FIG. 7 is a flowchart illustrating the image reading processing routine.

FIG. 8 is a schematic view illustrating an example of a screen displayed on a display unit.

FIG. 9 is a schematic view illustrating an example of a screen displayed on the display unit.

### DESCRIPTION OF EXEMPLARY EMBODIMENTS

An embodiment of an image reading device is described below with reference to the drawings.

The image reading device is a sheet-feed scanner in which a fixed reading unit reads a reading material being conveyed, for example.

### Image Reading Device 11

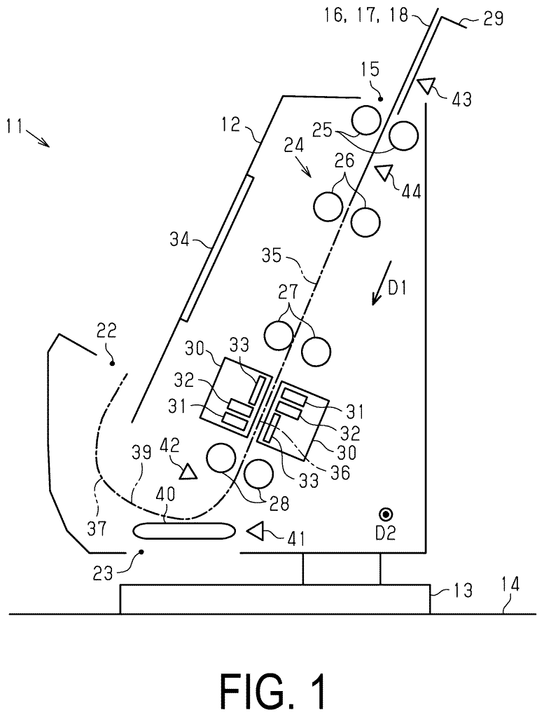

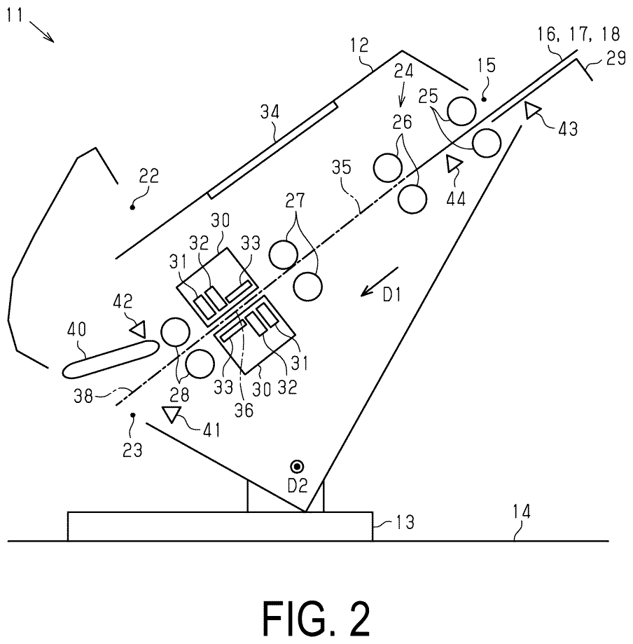

As illustrated in FIGS. 1 and 2, an image reading device 11 includes a device body 12 and a supporting unit 13. The device body 12 is supported by the supporting unit 13. The supporting unit 13 is placed on a horizontal placing surface 14 in a state of supporting the device body 12, for example.

### Device Body 12

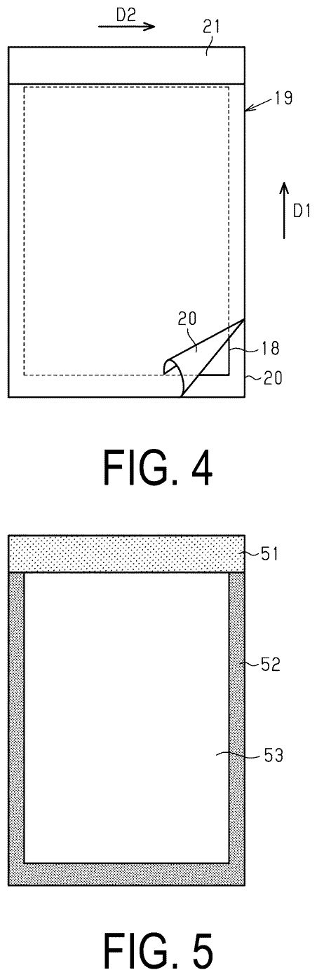

As illustrated in FIGS. 1 and 2, a supply port 15 and one or more outlets open at the device body 12. The supply port 15 is an opening through which reading material 16 is supplied. The reading material 16 includes a document 17 such as flat sheets, a reading object 18 such as a photograph and a booklet thicker than the document 17, and a carrier sheet 19 that can sandwich the reading object 18 (see FIG. 4). The thickness of the document 17 is approximately 0.09 mm, for example. The thickness of the photograph is approximately 0.23 mm, for example. The booklet such as a passport is substantially thicker than a photograph, for example. The reading object 18 does not include the document 17.

As illustrated in FIG. 4, the carrier sheet 19 includes two sheets 20 for sandwiching the reading object 18, and a joining part 21 where peripheral portions of the two sheets 20 are partially joined to each other. The two sheets 20 have a rectangular shape, for example. In this example, one of the two sheets 20 is constituted by a colorless transparent film and the other is constituted by gray thick paper, for example.

The two sheets 20 are joined to each other at their one short side portions by the white joining part 21 with a rectangular plate shape in a state of being stacked so as to be entirely aligned. The joining part 21 is a leading end portion when the carrier sheet 19 is conveyed. Note that each of the two sheets 20 may be constituted by a colorless transparent film. In this case, the hardness of the film may be adjusted as necessary.

As illustrated in FIGS. 1 and 2, the reading material 16 enters the device body 12 through the supply port 15. The outlet is an opening through which the reading material 16 is ejected. The reading material 16 is ejected from the inside of the device body 12 through the outlet. In this example, at the device body 12, a first outlet 22 and a second outlet 23 open as the outlet.

The device body 12 is configured such that the posture can be switched. For example, the posture of the device body 12 is switched when the device body 12 rotates with respect to the supporting unit 13. The device body 12 is switched between a first posture and a second posture, for example. In FIG. 1, the device body 12 is in the first posture. In FIG. 2, the device body 12 is in the second posture. When the device body 12 rotates clockwise in FIG. 1, the device body 12 is switched from the first posture to the second posture illustrated in FIG. 2.

The inclination of the device body 12 with respect to the supporting unit 13 differs between the case where the device body 12 is in the first posture and the case where the device body 12 is in the second posture. In the case where the device body 12 is in the first posture, the space occupied by the image reading device 11 is reduced than the case where the device body 12 is in the second posture.

### Conveyance Unit 24

As illustrated in FIGS. 1 and 2, the device body 12 includes a conveyance unit 24 inside. The conveyance unit 24 is configured to be able to convey the reading material 16. That is, the conveyance unit 24 is configured to be able to convey the document 17, the single reading object 18, and the reading object 18 sandwiched by the carrier sheet 19. The conveyance unit 24 includes one or more rollers, for example. The conveyance unit 24 rotates with power supplied from a conveyance motor, which is not illustrated in the drawing. The conveyance unit 24 includes a first roller pair 25, a second roller pair 26, a third roller pair 27, and a fourth roller pair 28, for example. The conveyance unit 24 conveys the reading material 16 in a sub-scanning direction D1.

### Tray 29

As illustrated in FIGS. 1 and 2, the device body 12 includes a tray 29. The tray 29 extends from the inside of the device body 12 to the outside of the device body 12 through the supply port 15. The reading material 16 before the reading is set on the tray 29. That is, the document 17, the reading object 18, or the reading object 18 sandwiched by the carrier sheet 19 before the reading is set on the tray 29.

### Reading Unit 30

As illustrated in FIGS. 1 and 2, the device body 12 includes one or more reading units 30 inside. The reading unit 30 is configured to read the image of the reading material 16 conveyed by the conveyance unit 24. That is, the reading unit 30 is configured to read the image of the document 17, the reading object 18, and the reading object 18 sandwiched by the carrier sheet 19 conveyed by the conveyance unit 24.

The device body 12 includes two reading units 30, for example. The two reading units 30 are disposed facing each other. The reading unit 30 is elongated and extended in a main scanning direction D2. The main scanning direction D2 is a direction different from the sub- scanning direction D1. The main scanning direction D2 is a direction orthogonal to the sub- scanning direction D1, for example.

The two reading units 30 read respective different surfaces of the document 17 and the reading object 18, for example. One of the two reading units 30 reads the surface of the document 17 and the reading object 18, while the other reads the back surface of the document 17 and the reading object 18. Thus, the image reading device 11 can read one surface of the document 17 and the reading object 18, or both surfaces of the document 17 and the reading object 18.

The reading unit 30 includes a light source 31. The light source 31 is an LED, a fluorescence lamp, or the like, for example. The light source 31 emits light toward the opposing reading unit 30. The reading unit 30 includes a plurality of image sensors 32. The plurality of image sensors 32 are disposed side by side in the main scanning direction D2. The plurality of image sensors 32 are modularized.

The image sensor 32 is a contact image sensor, for example. Specifically, the image sensor 32 is a CMOS image sensor. The image sensor 32 performs optoelectronic conversion of received light. The image sensor 32 outputs an output signal of a value corresponding to the light reception amount.

The image sensor 32 may be a monochrome sensor or a color sensor. The reading unit 30 may be configured to read the document 17 and the reading object 18 in full color. For example, the reading unit 30 may be configured to read the document 17 and the reading object 18 in three colors of RGB. The reading unit 30 may be configured to read the document 17 and the reading object 18 in grey scale.

The reading unit 30 includes a background plate 33. The background plate 33 faces the image sensor 32 and the light source 31 provided in another reading unit 30, for example. Light is applied to the background plate 33 from the light source 31 provided in the opposing reading unit 30. The background plate 33 reflects the applied light. The light reflected by the background plate 33 enters the image sensor 32 provided in the reading unit 30 facing this background plate 33. The background plate 33 is read by the image sensor 32 together with the document 17 and the reading object 18. The background plate 33 is read as a background by the image sensor 32 together with the document 17 and the reading object 18.

In the background plate 33, at least the surface facing the image sensor 32 has a color except for white and black, for example. The background plate 33 has gray color, for example. The color of the background plate 33 may be a color with which the background can be distinguished from the document 17 and the reading object 18 when the image sensor 32 reads the background plate 33 together with the document 17 and the reading object 18.

For example, in the case where the document 17 and the reading object 18 whose base color is blue are frequently used, colors other than blue may be selected as the color. For example, in the case where the document 17 and the reading object 18 whose base color is green are frequently used, colors other than green may be selected as the color. For example, in the case where the document 17 and the reading object 18 whose base color is red are frequently used, colors other than red may be selected as the color. In this example, without being limited to white, gray is employed as an example of the color because even the document 17 and the reading object 18 with chromatic colors such as blue, green and red can be distinguished from the background.

### Display Unit 34

As illustrated in FIGS. 1 and 2, the device body 12 includes a display unit 34 at the outer surface. The display unit 34 is constituted by a touch panel, for example. The display unit 34 displays various messages. The display unit 34 receives an input of various information from the user. The various information includes information about whether the reading object 18 is conveyed by the conveyance unit 24 by using the carrier sheet 19. Thus, the display unit 34 functions as a reception unit that receives input of the information about whether the reading object 18 is conveyed using the carrier sheet 19.

The image reading device 11 may include a communication unit that can communicate with a terminal operated by the user. A driver for communication with the image reading device 11 is installed in the terminal. The terminal is a personal computer, a smartphone, or the like, for example. In this case, the image reading device 11 receives, at the communication unit, an input of various information through the terminal operation by the user, and thus the communication unit functions as a reception unit.

### Configuration of Path in Device Body 12

As illustrated in FIGS. 1 and 2, the device body 12 includes, inside the device body 12, a conveyance path 35 for conveying the reading material 16 from the supply port 15 to a position facing the reading unit 30 with the conveyance unit 24. The conveyance path 35 extends in a straight-line shape in the sub-scanning direction D1. A portion facing the reading unit 30 in the conveyance path 35 is a reading conveyance path 36, which has a straight-line shape.

The device body 12 includes an ejection path inside. This ejection path includes a first ejection path 37 and a second ejection path 38, for example. The first ejection path 37 is coupled to the reading conveyance path 36. The first ejection path 37 extends toward the first outlet 22 from the portion coupled to the reading conveyance path 36. The first ejection path 37 is a path through which the document 17 after the image is read by the reading unit 30 is ejected from the first outlet 22.

The first ejection path 37 is a path including a curved portion 39 through which the document 17 after the image is read by the reading unit 30 is inverted by curving the document 17 in a U-shape. The first ejection path 37 is used when the device body 12 is in the first posture, for example. That is, when the device body 12 is in the first posture, the document 17 is conveyed in the first ejection path 37.

The second ejection path 38 is coupled to the reading conveyance path 36. The second ejection path 38 extends from the portion coupled to the reading conveyance path 36 toward the second outlet 23. The second ejection path 38 is a path through which the carrier sheet 19 and the reading object 18 after the image is read by the reading unit 30 are ejected from the second outlet 23.

That is, the second ejection path 38 is a path through which the single reading object 18 and the reading object 18 sandwiched by the carrier sheet 19 after the image is read by the reading unit 30 are ejected from the second outlet 23. The second ejection path 38 is a path extending in a straight line or straight-line shape. The second ejection path 38 does not include curved portions such as the curved portion 39. The second ejection path 38 is a path through which the carrier sheet 19 and the reading object 18 are ejected from the second outlet 23 without being inverted.

The second ejection path 38 is used when the device body 12 is in the second posture, for example. That is, when the device body 12 is in the second posture, the carrier sheet 19 and the reading object 18 are conveyed in the second ejection path 38. In the image reading device 11 of this example, the ejection path to be used is switched between the first ejection path 37 and the second ejection path 38 by the posture of the device body 12. When the device body 12 is in the first posture, the conveyance path 35 and the first ejection path 37 are coupled to each other. When the device body 12 is in the second posture, the conveyance path 35 and the second ejection path 38 are coupled to each other.

When the posture of the device body 12 is switched, the angle between the reading conveyance path 36 and the placing surface 14 changes. When the device body 12 is in the first posture, the angle between the reading conveyance path 36 and the placing surface 14 is an acute angle. When the device body 12 is in the second posture, the angle between the reading conveyance path 36 and the placing surface 14 is smaller than when the device body 12 is in the first posture.

In the image reading device 11, the ejection path suitable for the conveyance of the reading material 16 differs depending on the type of the reading material 16 such as the document 17, the carrier sheet 19 and the reading object 18. For example, when reading the reading material 16 (the reading object 18 or the reading object 18 sandwiched by the carrier sheet 19) with a large thickness, the second ejection path 38 may be used. The reason for this is that in the case where the thickness of the reading material 16 is large, conveyance defects may be caused when the reading material 16 passes through the curved portion 39.

Accordingly, when reading the reading material 16 (document 17) with a small thickness, the first ejection path 37 can be used. When reading the reading material 16 with a small thickness, the second ejection path 38 may also be used as well as the first ejection path 37. That is, when using the first ejection path 37, the type of the reading material 16 is limited. On the other hand, when using the second ejection path 38, the type of the reading material 16 is not limited.

### Configuration for Switching Ejection Path

As illustrated in FIGS. 1 and 2, the device body 12 includes a path switching member 40. The path switching member 40 is constituted by a flap, for example. The path switching member 40 switches the ejection path through which the reading material 16 is conveyed, to the first ejection path 37 or the second ejection path 38. The path switching member 40 switches the ejection path through which the reading material 16 is conveyed by blocking the first ejection path 37 or the second ejection path 38. When the path switching member 40 blocks the first ejection path 37, the reading material 16 is conveyed through the second ejection path 38. When the path switching member 40 blocks the second ejection path 38, the reading material 16 is conveyed through the first ejection path 37.

The path switching member 40 is linked with the posture of the device body 12, for example. When the device body 12 is in the first posture, the path switching member 40 blocks the second ejection path 38. When the device body 12 is in the second posture, the path switching member 40 blocks the first ejection path 37. The path switching member 40 may be displaced regardless of the posture of the device body 12. That is, the ejection path may be switched by the path switching member 40 regardless of the posture of the device body 12.

The image reading device 11 may include one or more sensors, for example. The image reading device 11 may include a sensor that detects the state of the reading material 16, a sensor that detects the state of the image reading device 11, or the like, for example.

The image reading device 11 may include one or more posture detection sensors that detect the posture of the device body 12, for example. The image reading device 11 may include a first posture detection sensor 41 that detects that the device body 12 is in the first posture, for example. The first posture detection sensor 41 is configured to detect the path switching member 40 blocking the second ejection path 38, for example. Thus, when the first posture detection sensor 41 detects the path switching member 40, it is possible to determine that the device body 12 is in the first posture.

The image reading device 11 may include a second posture detection sensor 42 that detects that the device body 12 is in the second posture, for example. The second posture detection sensor 42 is configured to detect the path switching member 40 blocking the first ejection path 37, for example. Thus, when the second posture detection sensor 42 detects the path switching member 40, it is possible to determine that the device body 12 is in the second posture.

The image reading device 11 may be configured such that it is detected that the device body 12 is in the first posture when the first posture detection sensor 41 detects the path switching member 40, and that it is detected that the device body 12 is in the second posture when the first posture detection sensor 41 does not detect the path switching member 40.

Alternatively, the image reading device 11 may be configured such that it is detected that the device body 12 is in the second posture when the second posture detection sensor 42 detects the path switching member 40, and that it is detected that the device body 12 is in the first posture when the second posture detection sensor 42 does not detect the path switching member 40. In this manner, it suffices to provide one posture detection sensor.

The posture detection sensor is not limited to the sensor that detects the path switching member 40, and may be a gyro sensor, for example. In the case where the posture detection sensor is a gyro sensor, the image reading device 11 may separately include a sensor that detects the position of the path switching member 40.

The image reading device 11 may include a size detection sensor 43 that detects the size of the reading material 16 set on the tray 29, for example. The size detection sensor 43 is located at the tray 29, for example. The size detection sensor 43 includes a plurality of optical sensors, for example. The plurality of optical sensors provided in the size detection sensor 43 are disposed in a line on the tray 29.

The size detection sensor 43 detects the size of the reading material 16 based on the detection result of the plurality of optical sensors. For example, the greater the size of the reading material 16 set on the tray 29, the larger the number of optical sensors overlapping the reading material 16. In this manner, the size detection sensor 43 detects the size of the reading material 16 in accordance with the number of optical sensors overlapping the reading material 16.

The image reading device 11 may include an overlapping feed detection sensor 44 that detects the thickness of the reading material 16 sent out from the tray 29. The overlapping feed detection sensor 44 is located near the tray 29 in the device body 12, for example. The overlapping feed detection sensor 44 is constituted by an ultrasound sensor, for example.

The overlapping feeding refers to sending out of a plurality of the documents 17, which are a type of the reading material 16, in an overlapped state from the tray 29. When the overlapping feeding of the document 17 occurs, the thickness of the document 17 detected at the overlapping feed detection sensor 44 becomes larger than the thickness of a single document 17. Thus, whether there is overlapping feeding of the document 17 can be determined by detecting the thickness of the document 17 sent out from the tray 29 with the overlapping feed detection sensor 44.

### Electrical Configuration of Image Reading Device 11

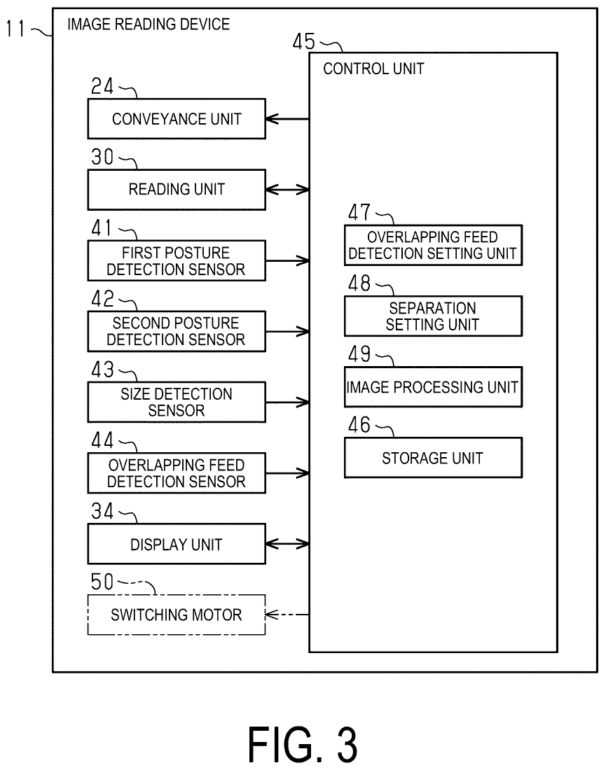

As illustrated in FIG. 3, the image reading device 11 includes a control unit 45. The control unit 45 controls the image reading device 11. The control unit 45 controls the conveyance unit 24, the reading unit 30, the display unit 34, and the like, for example. The control unit 45 may be configured as a circuit including: (α) one or more processors that execute various processes in accordance with a computer program; (β) one or more dedicated hardware circuits such as an application-specific integrated circuit that execute at least some of various processes; or (γ) a combination of them.

The processor includes a central processing unit (CPU) and a memory such as a random-access memory (RAM) and a read-only memory (ROM). The memory stores a program code or a command configured to cause the CPU to execute processing. The memory, i.e., a computer readable medium, includes all types of readable media that are accessible with a general-purpose or dedicated computer.

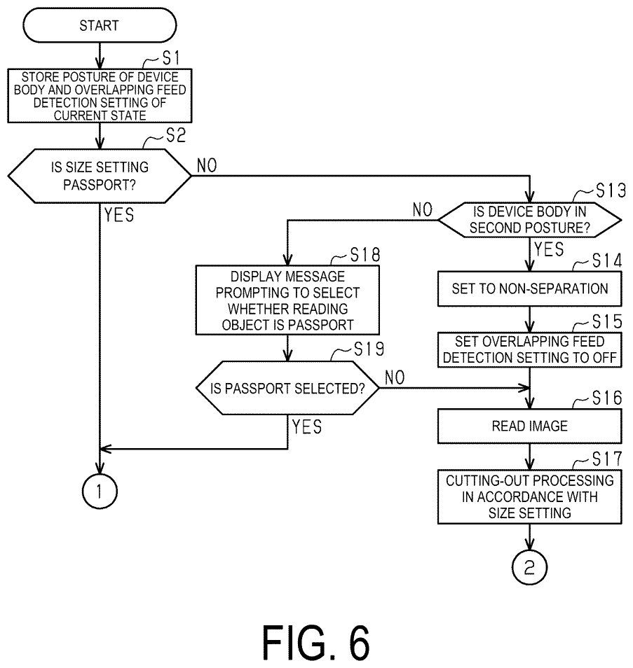

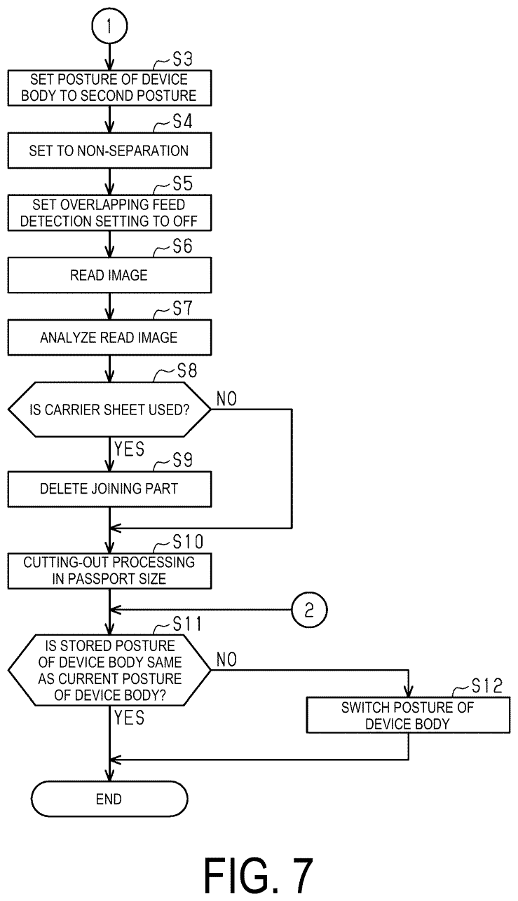

As illustrated in FIG. 3, the control unit 45 includes a storage unit 46. That is, the image reading device 11 includes the storage unit 46. The storage unit 46 is constituted by a nonvolatile memory, for example. The storage unit 46 stores various programs including an image reading processing routine illustrated in the flowcharts of FIGS. 6 and 7, various settings including the size setting of the reading material 16, various information, various messages to be displayed on the display unit 34, and the like.

The control unit 45 is electrically coupled to each of the conveyance unit 24, the reading unit 30, the first posture detection sensor 41, the second posture detection sensor 42, the size detection sensor 43, the overlapping feed detection sensor 44, and the display unit 34. The control unit 45 constructs an overlapping feed detection setting unit 47, a separation setting unit 48, and an image processing unit 49 by executing the program stored in the storage unit 46, for example. That is, the control unit 45 includes the overlapping feed detection setting unit 47, the separation setting unit 48, and the image processing unit 49.

The overlapping feed detection setting unit 47 switches an overlapping feed detection setting between the on-setting for detecting the overlapping feeding of the reading material 16 with the overlapping feed detection sensor 44, and the off-setting for not detecting the overlapping feeding of the reading material 16 with the overlapping feed detection sensor 44. When the overlapping feed detection setting is the on-setting and a detection signal from the overlapping feed detection sensor 44 is received, the control unit 45 determines that there is overlapping feeding of the reading material 16. On the other hand, when the overlapping feed detection setting is in the off-setting and a detection signal from the overlapping feed detection sensor 44 is received, the control unit 45 does not determine that there is overlapping feeding of the reading material 16. When it is determined that there is overlapping feeding of the reading material 16, the control unit 45 stops the driving of the conveyance unit 24.

The separation setting unit 48 switches the setting between separation setting for conveying the reading material 16 while separating it one by one with the first roller pair 25 of the conveyance unit 24, and non-separation setting for conveying the reading material 16 without separating it one by one with the first roller pair 25 of the conveyance unit 24. In the separation setting, the first roller pair 25 operates to convey the reading material 16 while separating it one by one. In the non-separation setting, the first roller pair 25 operates to convey the reading material 16 without separating it.

The image processing unit 49 analyses and processes the image data read by the reading unit 30, for example. The image processing unit 49 deletes an unnecessary region and/or performs cutting-out processing of cutting out a required region in the image data read by the reading unit 30, for example. The image processing unit 49 determines whether the reading object 18 is being conveyed using the carrier sheet 19 based on the color data of the image read by the reading unit 30, for example.

The control unit 45 acquires reading material information, which is information related to the reading material 16 to be read by the reading unit 30. The control unit 45 may acquire the reading material information based on the detection signal of the sensor, or acquire the reading material information from input information input by the user operating the display unit 34. The reading material information includes posture information, for example. The posture information is information indicating the posture of the device body 12. The posture information includes information indicating that the device body 12 is in the first posture, or information indicating that the device body 12 is in the second posture, for example.

The reading material information includes the ejection path information, for example. The ejection path information is information indicating the ejection path through which the reading material 16 is conveyed after the image is read by the reading unit 30. The ejection path information includes information indicating that the reading material 16 is conveyed through the first ejection path 37, or information indicating that the reading material 16 is conveyed through the second ejection path 38, for example.

The reading material information includes use information, for example. The use information is information indicating whether the carrier sheet 19 is used. The use information is information indicating that the reading object 18 is conveyed in a state of being sandwiched by the carrier sheet 19, or information indicating that the reading object 18 is singly conveyed without being sandwiched by the carrier sheet 19, for example.

The reading material information includes reading material size information, for example. The reading material size information is information indicating the size of the reading material 16. The reading material information includes reading material thickness information, for example. The reading material thickness information is information indicating the thickness of the reading material 16.

The control unit 45 acquires the posture information and the ejection path information from the detection signal of the first posture detection sensor 41 and the detection signal of the second posture detection sensor 42, for example. The control unit 45 acquires the reading material size information from the detection signal of the size detection sensor 43, for example. The control unit 45 acquires the reading material thickness information from the detection signal of the overlapping feed detection sensor 44, for example.

The control unit 45 may acquire the use information from the detection signal of the first posture detection sensor 41 and the detection signal of the second posture detection sensor 42. For example, the use information and the posture information or the ejection path information may be associated with each other. For example, in the case where the reading object 18 is conveyed in a state of being sandwiched by the carrier sheet 19, the second ejection path 38 is used. The control unit 45 may acquire the use information from the detection signal of the overlapping feed detection sensor 44.

A sensor for detecting the carrier sheet 19 may be provided at a position upstream of the reading unit 30 in the conveyance path 35 such that the control unit 45 acquires the use information from the detection signal of this sensor. This sensor may detect a mark, a hole, or the like provided in advance at the joining part 21 of the carrier sheet 19, for example.

The control unit 45 acquires image data from the reading unit 30. That is, the control unit 45 receives a detection signal from the reading unit 30. The control unit 45 acquires the image data through A/D conversion of the detection signal. When acquiring the image data, the control unit 45 may perform shading correction, gamma correction, or the like on the detection signal.

### Image Reading Processing Routine

Next, the image reading processing routine executed by the control unit 45 is described with reference to the flowchart illustrated in FIGS. 6 and 7. The image reading processing routine is executed by the control unit 45 when the user performs an operation of starting the reading on the display unit 34. Here, the following description will be made assuming that the reading object 18 is a passport, which is a type of booklet.

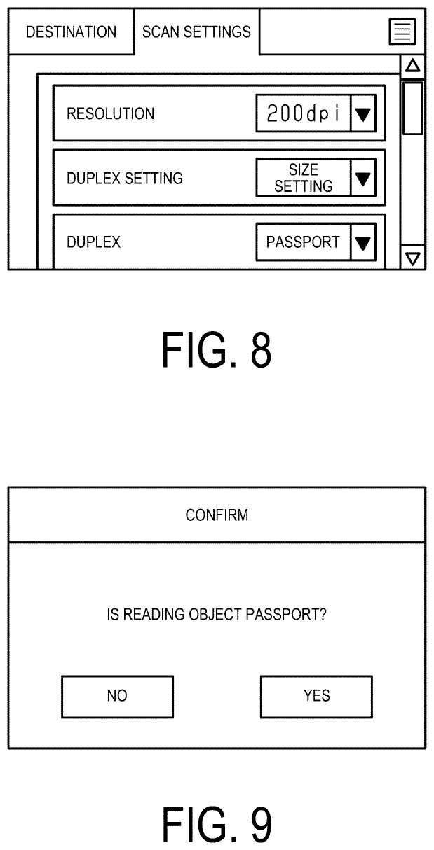

When the image reading processing routine is executed, first, the control unit 45 stores the overlapping feed detection setting and the posture of the device body 12 of the current state (step S1). Subsequently, the control unit 45 determines whether the user has selected the passport as the size setting of the reading object 18 from the screen of the display unit 34 illustrated in FIG. 8 (step S2), for example. The size setting is selected in a pull-down manner as illustrated in FIG. 8, for example.

When the determination result of step S2 is positive, the control unit 45 displays a message prompting to set the posture of the device body 12 to the second posture on the display unit 34 to request the user to manually set the posture of the device body 12 to the second posture (step S3). As illustrated with the chain double-dashed line in FIG. 3, in the case where the image reading device 11 includes a switching motor 50 that switches the posture of the device body 12 between the first posture and the second posture, the control unit 45 may control the driving of the switching motor 50 to automatically set the posture of the device body 12 to the second posture. In the case where the posture of the device body 12 is originally the second posture, the control unit 45 advances the processing to step S4 by skipping the processing of step S3.

The passport is normally set to the tray 29 in a state of being sandwiched between the carrier sheet 19 (the state illustrated in FIG. 4), i.e., by using the carrier sheet 19. Accordingly, when the user selects the passport as the size setting of the reading material 16 from the screen of the display unit 34 illustrated in FIG. 8 at step S2, the display unit 34 receives the selection as information indicating that the passport is conveyed using the carrier sheet 19. The reception of the information at the display unit 34 is determined by the control unit 45.

When the posture of the device body 12 is set to the second posture, the control unit 45 sets the conveyance unit 24 to the non-separation setting (step S4). Subsequently, the control unit 45 sets the overlapping feed detection setting to the off-setting (step S5). Subsequently, the control unit 45 conveys the passport set on the tray 29 by driving the conveyance unit 24 and causes the reading unit 30 to read the image (step S6). Subsequently, the control unit 45 analyses the image read by the reading unit 30 at step S6 (step S7).

Subsequently, the control unit 45 determines whether the carrier sheet 19 is used for the conveyance of the passport based on the result of the image analysis at step S7 (step S8). A carrier sheet dedicated to a passport is used as the carrier sheet 19 used for the passport, and as such the color of the carrier sheet 19 is set in advance. In the carrier sheet 19 of this example, the color of the joining part 21 is white and the color of parts other than the joining part 21 (thick paper color) is gray.

Thus, at step S7, the control unit 45 performs histogram analysis from the image data read at step S6 (see FIG. 5). When a uniform white first background region 51 and a uniform gray second background region 52 are detected from the result of this histogram analysis, the control unit 45 determines that the carrier sheet 19 is used for the conveyance of the passport. The first background region 51 is the region of the joining part 21 of the carrier sheet 19. The second background region 52 is the region of the thick paper of the carrier sheet 19. A region 53 in FIG. 5 is the region of the passport (the reading object 18).

When the first background region 51 and the second background region 52 are not detected from the above-described histogram analysis result, the control unit 45 determines that the carrier sheet 19 is not used for the conveyance of the passport. The control unit 45 may determine whether the carrier sheet 19 is used for the conveyance of the passport based on whether there is detection of only the first background region 51.

In addition, the width (the length in the main scanning direction D2) of the joining part 21 of the carrier sheet 19 is set in advance. At step S7, the control unit 45 calculates the width of the joining part 21 based on the image data read at step S6 (see FIG. 5). The control unit 45 may determine whether the carrier sheet 19 is used for the conveyance of the passport at step S8 by determining whether the calculated width described above matches a predetermined width of the joining part 21.

When the determination result of step S8 is positive, the control unit 45 performs processing of deleting the first background region 51 from the image data read at step S6 as predetermined processing (step S9). Subsequently, at step S9, the control unit 45 performs cutting-out processing in a passport size from the image data read at step S6 from which the first background region 51 has been deleted (step S10). In this manner, image data of only the passport is appropriately cut out from the image data read at step S6. When the determination result of step S8 is negative, the control unit 45 advances the processing to step S10.

At steps S8 and S9, when it is determined that the passport is being conveyed using the carrier sheet 19, the control unit 45 performs predetermined specialized processing on the image data of the passport read by the reading unit 30 at step S6. As described above, the predetermined processing is processing of deleting the first background region 51 from the image data of the passport read by the reading unit 30 at step S6. Accordingly, at step S10, the image data of only the passport is appropriately cut out from the image data read at step S6.

Incidentally, in the case where the passport is being conveyed using the carrier sheet 19, if the predetermined processing is not performed at step S9, the image data of only the passport cannot be appropriately cut out at step S10 from the image data read at step S6. That is, at step S10, the cutting-out position is shifted by the amount corresponding to the first background region 51, and consequently the first background region 51 is partially included in the image data of the passport cut out into the passport size.

On the other hand, at step S8, when it is determined that the passport is being conveyed without using the carrier sheet 19, the control unit 45 skips step S9 and advances the processing to step S10. That is, when it is determined that the passport is being conveyed without using the carrier sheet 19, the control unit 45 does not perform the above-described predetermined processing on the image data of the passport read by the reading unit 30 at step S6. Accordingly, at step S10, the image data of only the passport is appropriately cut out from the image data read at step S6.

Incidentally, when the above-described predetermined processing is performed at step S9 in the case where the passport is not conveyed using the carrier sheet 19, the image data of only the passport cannot be appropriately cut out at step S10 from the image data read at step S6. That is, at step S10, the cutting-out position is shifted by the amount corresponding to the first background region 51, and consequently the image data of the passport cut out into the passport size is partially lost.

After performing the processing of step S10, the control unit 45 determines whether the current posture of the device body 12 is the same as the posture of the device body 12 stored at step S1 (step S11). When the determination result of step S11 is positive, the control unit 45 terminates the image reading processing routine.

On the other hand, when the determination result of step S11 is negative, the control unit 45 displays a message prompting to switch the posture of the device body 12 on the display unit 34 to request the user to manually switch the posture of the device body 12 (step S12), and thereafter terminates the image reading processing routine. At step S12, the control unit 45 may control the driving of the switching motor 50 to automatically switch the posture of the device body 12 as at step S3.

When the determination result of step S2 is negative, the control unit 45 determines whether the posture of the device body 12 is in the second posture (step S13). When the determination result of step S13 is positive, the control unit 45 sets the conveyance unit 24 to the non-separation setting (step S14). Subsequently, the control unit 45 sets the overlapping feed detection setting to the off-setting (step S15).

Subsequently, the control unit 45 conveys the document 17 set on the tray 29 by driving the conveyance unit 24 and causes the reading unit 30 to read the image (step S16). Subsequently, the control unit 45 performs the cutting-out processing in accordance with the size setting of the document 17 from the image data read by the reading unit 30 at step S16 (step S17). Subsequently, the control unit 45 advances the processing to step S11.

In addition, when the determination result of step S13 is negative, the control unit 45 displays a message as that illustrated in FIG. 9 on the screen of the display unit 34. That is, the control unit 45 displays a message prompting to select whether the reading object is a passport on the screen of the display unit 34 (step S18). Subsequently, the control unit 45 determines the selection made by the user as to whether the reading object is a passport (step S19).

When it is determined at step S19 that the user has selected that the reading object is a passport (when the determination result of step S19 is positive), the control unit 45 advances the processing to step S3. On the other hand, when it is determined at step S19 that the user has selected that the reading object is not a passport (when the determination result of step S19 is negative), the control unit 45 advances the processing to step S16.

### Operation of Image Reading Device 11

When the user has selected the passport in a pull-down manner as the size setting from the screen of the display unit 34 illustrated in FIG. 8 in order to read the passport (the reading object 18), a message prompting to manually set the posture of the device body 12 to the second posture is displayed on the display unit 34. When the user has set the posture of the device body 12 to the second posture and set the passport on the tray 29, the passport is smoothly conveyed by the conveyance unit 24 without being separated or detected as overlapping feeding, and the image is read by the reading unit 30.

At this time, when the user has set the passport sandwiched by the carrier sheet 19 on the tray 29, the joining part 21 of the carrier sheet 19 is deleted through the image processing, and thereafter the cutting-out processing of the image of the passport in the passport size is performed. Accordingly, the joining part 21 is not included in the cut-out image data, and the image data of only the passport is appropriately cut out. Thus, the passport can be appropriately read.

On the other hand, when the user has set only the passport on the tray 29 without using the carrier sheet 19, the cutting-out processing of the image of the passport in the passport size is performed without deleting the region of the joining part 21 of the carrier sheet 19 in the image processing. Accordingly, the image data of only the passport is appropriately cut out without shifting the cutting-out position of the cut-out image data.

Incidentally, in this case, when the cutting-out processing of the image of the passport in the passport size is performed after deleting the region of the joining part 21 of the carrier sheet 19 in the image processing, the cutting-out position of the cut-out image data is shifted by the amount corresponding to the region of the joining part 21. As a result, the image data of the passport cut out into the passport size is partially lost, and consequently the passport cannot be appropriately read.

As described above, in the image reading device 11, even when the user has set the passport on the tray 29 by using the carrier sheet 19 or when the user has set the passport on the tray 29 without using the carrier sheet 19, the image of the passport can be appropriately read.

### Effect of Embodiment

According to the above-described embodiment, the following effects are provided.

(1) In the image reading device 11, when it is determined that the reading object 18 is being conveyed using the carrier sheet 19, the control unit 45 performs predetermined processing on the image read by the reading unit 30. When it is determined that the reading object 18 is being conveyed without using the carrier sheet 19, the control unit 45 does not perform the predetermined processing on the image read by the reading unit 30.

Normally, when the reading object 18 is being conveyed using the carrier sheet 19 and predetermined processing is performed on the image read by the reading unit 30, the image of the reading object 18 can be appropriately read. On the other hand, when the reading object 18 is being conveyed without using the carrier sheet 19 and the above-described predetermined processing is performed on the image read by the reading unit 30, the image of the reading object 18 may not be appropriately read.

In view of this, with this configuration, when the reading object 18 is being conveyed using the carrier sheet 19, predetermined processing is performed on the image read by the reading unit 30. On the other hand, when the reading object 18 is being conveyed without using the carrier sheet 19, the above-described predetermined processing is not performed on the image read by the reading unit 30. Accordingly, even when the reading object 18 is conveyed using the carrier sheet 19 or when the reading object 18 is conveyed without using the carrier sheet 19, the image of the reading object 18 can be appropriately read.

(2) In the image reading device 11, the carrier sheet 19 includes the two sheets 20 for sandwiching the reading object 18, and the joining part 21 where peripheral portions of the two sheets 20 are partially joined to each other. The above-described predetermined processing is processing of deleting the region of the joining part 21 (the first background region 51) in the image read by the reading unit 30.

With this configuration, the region of the joining part 21 is deleted in the image read by the reading unit 30, and thus the image excluding the region of the joining part 21 can be generated.

(3) In the image reading device 11, the control unit 45 determines whether the reading object 18 is being conveyed using the carrier sheet 19 based on the image read by the reading unit 30.

With this configuration, whether the reading object 18 is being conveyed using the carrier sheet 19 is determined based on the image read by the reading unit 30, and thus it is not necessary to use a dedicated detection unit for detecting the carrier sheet 19. Thus, the configuration can be simplified in comparison with the case where a dedicated detection unit for detecting the carrier sheet 19 is used.

(4) The image reading device 11 includes the conveyance path 35 for conveying the carrier sheet 19, the reading object 18, and the document 17 to a position facing the reading unit 30, the first ejection path 37 coupled to the conveyance path 35 and through which the document 17 after being read by the reading unit 30 is ejected, and the second ejection path 38 coupled to the conveyance path 35 and through which the carrier sheet 19 and the reading object 18 after being read by the reading unit 30 are ejected.

With this configuration, the first ejection path 37 can have a configuration suitable for ejection of the document 17, and the second ejection path 38 can have a configuration suitable for ejection of the carrier sheet 19 and the reading object 18. Accordingly, the document 17, the carrier sheet 19, and the reading object 18 after being read by the reading unit 30 can be appropriately ejected.

(5) In the image reading device 11, the first ejection path 37 is a path including the curved portion 39 through which the document 17 is inverted. The second ejection path 38 is a path through which the carrier sheet 19 and the reading object 18 are ejected without being inverted.

With this configuration, since the first ejection path 37 has the configuration including the curved portion 39, the space for ejecting the document 17 can be reduced in comparison with a configuration that does not include the curved portion 39. Thus, the space occupied by the image reading device 11 during use can be reduced.

(6) The image reading device 11 includes the device body 12 including the reading unit 30, and the supporting unit 13 that is placed on the placing surface 14 and supports the device body 12. The device body 12 is configured to be switched between the first posture at which the angle between the reading conveyance path 36 having a straight-line shape and facing the reading unit 30 and the placing surface 14 is an acute angle, and the second posture at which the above-described angle is smaller than that of the first posture. When the device body 12 is in the first posture, the conveyance path 35 and the first ejection path 37 are coupled to each other. When the device body 12 is in the second posture, the conveyance path 35 and the second ejection path 38 are coupled to each other.

With this configuration, by switching the posture of the device body 12 between the first posture and the second posture, the state can be switched between the state where the conveyance path 35 and the first ejection path 37 are coupled to each other, and the state where the conveyance path 35 and the second ejection path 38 are coupled to each other. Thus, the user-friendliness is improved.

### Modifications

The above-described embodiment may be modified as follows for implementation. The above-described embodiments and the following modifications may be combined for implementation insofar as they are not technically inconsistent.

The device body 12 need not necessarily be configured to switch the posture between the first posture and the second posture.

The device body 12 need not necessarily be configured such that the angle between the reading conveyance path 36 and the placing surface 14 is an acute angle in the first posture.

The device body 12 need not necessarily be configured such that the angle between the reading conveyance path 36 and the placing surface 14 in the second posture is smaller than that of the first posture.

When the device body 12 is in the first posture, the conveyance path 35 and the first ejection path 37 need not necessarily be coupled to each other.

When the device body 12 is in the second posture, the conveyance path 35 and the second ejection path 38 need not necessarily be coupled to each other.

The first ejection path 37 need not necessarily be a path including the curved portion 39 through which the document 17 is inverted.

The second ejection path 38 need not necessarily be a path through which the carrier sheet 19 and the reading object 18 are ejected without being inverted.

The first ejection path 37 may be omitted.

The carrier sheet 19 need not necessarily include the two sheets 20 for sandwiching the reading object 18, and the joining part 21 where peripheral portions of the two sheets 20 are partially joined to each other.

The third roller pair 27 may be constituted by a first driving roller and a second driving roller that are provided to sandwich the conveyance path 35, and rotate with the power from a conveyance motor not illustrated in the drawing. The fourth roller pair 28 may be constituted by a third driving roller and a fourth driving roller that are provided to sandwich the conveyance path 35, and rotate with the power from a conveyance motor not illustrated in the drawing. With the third roller pair 27 and the fourth roller pair 28 constituted by the driving rollers, the passport can be more stably conveyed.

The predetermined processing need not necessarily be processing of deleting the region of the joining part 21 in the image read by the reading unit 30. That is, the predetermined processing may be color correction processing corresponding to the carrier sheet 19 (correction of the influence of colorless transparent film), a background color setting, a white balance correction, or the like for the read image.

In the case where the carrier sheet 19 is used for the conveyance of the passport, the region of the joining part 21 may be deleted by controlling the read timing of the reading unit 30 for reading the passport sandwiched by the carrier sheet 19 and conveyed by the conveyance unit 24. That is, the region of the joining part 21 may be deleted by the control unit 45 by controlling the operations of the conveyance unit 24 and the reading unit 30 such that the joining part 21 is not read by the reading unit 30.

In the case where the reading object 18 larger than the carrier sheet 19 is sandwiched by the carrier sheet 19, automatic cutting-out processing may be performed on the portion of the read image remaining after the deletion of the joining part 21, instead of cutting- out it in the size of the reading object 18. In this manner, an expected read result can be obtained even with the reading object 18 larger than the width of the carrier sheet 19.

While a passport is selected as the size setting in the above-described embodiment, the same applies to the case where a photograph is selected as the size setting, as in the case where a passport is selected as the size setting. In the case where a photograph is selected as the size setting, it may be conveyed in the separation setting, not in the non-separation setting. In this case, a specific setting such as a color image type setting may be automatically changed to a setting suitable for photographs.

In the case where the above-described image reading processing routine is applied to an image reading device provided with no posture switching mechanism, steps S1, S3, S11 to S15, S18 and S19 may be omitted in the above-described image reading processing routine.

In the case where the image reading processing routine (program) is shared between the above-described image reading device 11 provided with the posture switching mechanism and an image reading device provided with no posture switching mechanism, a determination step for determining whether the device has the posture switching mechanism may be provided at the start of the image reading processing routine. In this case, the determination step may be provided after the negative determination at step S2.

The image reading processing routine (program) may be recorded in the recording medium.

Technical ideas derived from the above-described embodiment and modifications and operational effects thereof are described below.

(A) An image reading device includes a conveyance unit configured to convey a carrier sheet and a reading object, the carrier sheet being configured to sandwich the reading object thicker than a document, a reading unit configured to read an image of the reading object conveyed by the conveyance unit, a reception unit configured to receive an input of information about whether the reading object is conveyed using the carrier sheet, and a control unit configured to determine whether the reading object is being conveyed using the carrier sheet and control the reception unit. In a case in which information indicating that the reading object is conveyed using the carrier sheet is received by the reception unit, the control unit performs predetermined processing on the image read by the reading unit when it is determined that the reading object is being conveyed using the carrier sheet, and the control unit does not perform the predetermined processing on the image read by the reading unit when it is determined that the reading object is being conveyed without using the carrier sheet.

Normally, when predetermined processing is performed on the image read by the reading unit in the case where the reading object is conveyed using the carrier sheet, the image of the reading object can be appropriately read. On the other hand, when the above-described predetermined processing is performed on the image read by the reading unit in the case where the reading object is conveyed without using the carrier sheet, the image of the reading object may not be appropriately read.

In view of this, with this configuration, when the reading object is conveyed using the carrier sheet, the predetermined processing is performed on the image read by the reading unit. On the other hand, when the reading object is conveyed without using the carrier sheet, the above-described predetermined processing is not performed on the image read by the reading unit. Accordingly, even when the reading object is conveyed using the carrier sheet or when the reading object is conveyed without using the carrier sheet, the image of the reading object can be appropriately read.

(B) In the image reading device, the carrier sheet may include two sheets configured to sandwich the reading object, and a joining part where peripheral portions of the two sheets are joined to each other, and the predetermined processing may be processing of deleting a region of the joining part in the image read by the reading unit.

With this configuration, the region of the joining part is deleted in the image read by the reading unit, and thus the image excluding the region of the joining part can be generated.

(C) In the image reading device, the control unit may determine whether the reading object is being conveyed using the carrier sheet based on the image read by the reading unit.

With this configuration, whether the reading object is conveyed using the carrier sheet is determined based on the image read by the reading unit, and thus it is not necessary to use a dedicated detection unit for detecting the carrier sheet. Thus, the configuration can be simplified in comparison with the case where the dedicated detection unit for detecting the carrier sheet is used.

(D) The image reading device may further include a conveyance path configured to convey the carrier sheet, the reading object, and the document to a position facing the reading unit, a first ejection path coupled to the conveyance path and through which the document read by the reading unit is ejected, and a second ejection path coupled to the conveyance path and through which the carrier sheet and the reading object read by the reading unit are ejected.

With this configuration, the first ejection path can have a configuration suitable for ejection of a document, and the second ejection path can have a configuration suitable for ejection of a reading object thicker than the document and the carrier sheet. Accordingly, the reading object thicker than the document, the carrier sheet, and the document after being read by the reading unit can be appropriately ejected.

(E) In the image reading device, the first ejection path may be a path including a curved portion through which the document is inverted, and the second ejection path may be a path through which the carrier sheet and the reading object are ejected without being inverted.

With this configuration, the first ejection path includes the curved portion, and thus the space for ejection can be reduced in comparison with a configuration provided with no curved portion. Thus, the space occupied by the image reading device during use can be reduced.

(F) The image reading device may further include a device body including the reading unit, and a supporting unit that is placed on a placing surface and supports the device body. The device body may be configured to be switched between a first posture and a second posture, the first posture being a posture in which an angle between a reading conveyance path which has a straight-line shape and faces the reading unit and the placing surface is an acute angle, the second posture being a posture in which the angle is smaller than the angle of the first posture. The conveyance path and the first ejection path may be coupled to the device body when the device body is in the first posture, and the conveyance path and the second ejection path may be coupled to the device body when the device body is in the second posture.

With this configuration, by switching the posture of the device body between the first posture and the second posture, the state can be switched between the state where the conveyance path and the first ejection path are coupled to each other and the state where the conveyance path and the second ejection path are coupled to each other. Thus, the user-friendliness is improved.

(G) An image reading method is an image reading method in an image reading device, the image reading device including a conveyance unit configured to convey a carrier sheet and a reading object, the carrier sheet being configured to sandwich the reading object thicker than a document and the reading object, a reading unit configured to read an image of the reading object conveyed by the conveyance unit, and a reception unit configured to receive an input of information about whether the reading object is conveyed using the carrier sheet. The image reading device is configured to determine whether the reading object is being conveyed using the carrier sheet. The image reading method includes, in a case in which information indicating that the reading object is conveyed using the carrier sheet is received by the reception unit, performing predetermined processing on the image read by the reading unit when the reading object is being conveyed using the carrier sheet, and not performing the predetermined processing on the image read by the reading unit when the reading object is being conveyed without using the carrier sheet.

With this configuration, operational effects similar to those of the above-described image reading device can be achieved.

(H) A program is a non-transitory computer-readable storage medium storing a program executed by a computer included in an image reading device, the image reading device including a conveyance unit configured to convey a carrier sheet and a reading object, the carrier sheet being configured to sandwich the reading object thicker than a document and the reading object, a reading unit configured to read an image of the reading object conveyed by the conveyance unit, and a reception unit configured to receive an input of information about whether the reading object is conveyed using the carrier sheet. The image reading device is configured to determine whether the reading object is being conveyed using the carrier sheet. The program is configured to cause the computer to, in a case in which information indicating that the reading object is conveyed using the carrier sheet is received by the reception unit, perform predetermined specialized processing on the image read by the reading unit when the reading object is being conveyed using the carrier sheet, and not perform the predetermined processing on the image read by the reading unit when the reading object is being conveyed without using the carrier sheet.

With this configuration, operational effects similar to those of the above-described image reading device can be achieved.

What is claimed is:

1. An image reading device comprising:
a conveyance unit configured to convey a carrier sheet and a reading object, the carrier sheet being configured to sandwich the reading object thicker than a document;
a reading unit configured to read an image of the reading object conveyed by the conveyance unit;
a reception unit configured to receive an input of information about whether the reading object is conveyed using the carrier sheet;
a conveyance path through which the carrier sheet, the reading object, and the document are conveyed to a position facing the reading unit;
a first ejection path coupled to the conveyance path and through which the document read by the reading unit is ejected;
a second ejection path coupled to the conveyance path and through which the carrier sheet and the reading object read by the reading unit are ejected;
a control unit configured to determine whether the reading object is being conveyed using the carrier sheet and control the reception unit;
a device body including the reading unit; and
a supporting unit that is placed on a placing surface and supports the device body, wherein
the device body is configured to be switched between a first posture and a second posture, the first posture being a posture in which an angle between a reading conveyance path which has a straight-line shape and faces the reading unit and the placing surface is an acute angle, the second posture being a posture in which the angle is smaller than the angle of the first posture,
the conveyance path and the first ejection path are coupled to the device body when the device body is in the first posture, and
the conveyance path and the second ejection path are coupled to the device body when the device body is in the second posture,
wherein the device body is not able to convey the carrier sheet in the first posture and is able to convey the carrier sheet in the second posture,
wherein
when information indicating that the reading object is conveyed using the carrier sheet is received by the reception unit,
the control unit performs predetermined processing on the image read by the reading unit when it is determined that the reading object is being conveyed using the carrier sheet, and
the control unit does not perform the predetermined processing on the image read by the reading unit when it is determined that the reading object is being conveyed without using the carrier sheet.

2. The image reading device according to claim 1, wherein
the carrier sheet includes
two sheets configured to sandwich the reading object and
a joining part where peripheral portions of the two sheets are joined to each other and
the predetermined processing is processing of deleting a region of the joining part in the image read by the reading unit.

3. The image reading device according to claim 1, wherein the control unit determines whether the reading object is being conveyed using the carrier sheet based on the image read by the reading unit.

4. The image reading device according to claim 1, wherein
the first ejection path is a path including a curved portion through which the document is inverted and
the second ejection path is a path through which the carrier sheet and the reading object are ejected without being inverted.
